(19) United States
(12) Patent Application Publication
(10) Pub. No.: US 2015/0325954 A1
(43) Pub. Date: Nov. 12, 2015

(54) SUBSTRATE WITH A LOW DIELECTRIC CONSTANT MATERIAL AND METHOD OF MOLDING

(71) Applicant: TYCO ELECTRONICS CORPORATION, Berwyn, PA (US)

(72) Inventors: Mary Elizabeth Sullivan MALERVY, Downingtown, PA (US); Josh Harris GOLDEN, Santa Cruz, CA (US); Aleksandar Kolev ANGELOV, Harrisburg, PA (US)

(73) Assignee: TYCO ELECTRONICS CORPORATION, Berwyn, PA (US)

(21) Appl. No.: 14/270,930

(22) Filed: May 6, 2014

(51) Int. Cl. H01R 13/6461; B29C 45/00; C08J 9/00; B29C 45/14; H01R 13/6585; C08J 9/228

(52) U.S. Cl. CPC H01R 13/6461; H01R 13/6585; C08J 9/228; C08J 9/0066; B29C 45/14795; B29C 45/0001; C08J 2300/22; C08J 2300/24; B29L 2009/00

(57) ABSTRACT

Connectors and/or substrates which are made utilizing a low dielectric constant injection moldable polymer or other melt processable polymer, such as, but not limited to, thermoplastic material, thermoplastic composite material, thermoset material, thermoset composite material or a combination thereof. The low dielectric constant injection moldable polymer or other melt processable polymer support noise and/or crosstalk reductions for high speed signal transmission. The low dielectric constant material provides dielectric shielding between adjacent high speed signal lines. The reduced dielectric constant and reduced loss-tangent is created by forming voids or pores within the bulk plastic material, thus increasing the air, gas or void content, and thus decreasing the density and overall dielectric constant of such material. The porosity thus introduced into the shielding between adjacent transmission lines reduces crosstalk and other losses, and thus maintains signal integrity in connector/substrate designs.

### FIELD OF THE INVENTION

The present invention is directed to a connector or substrate with a low dielectric constant and a method of making the same. In particular, the invention is directed to a substrate which includes low dielectric constant injection moldable thermoplastic materials, thermoplastic composite materials, thermoset materials, thermoset composite materials or a combination thereof and which provides structural integrity and dielectric shielding between adjacent high speed signal lines.

### BACKGROUND OF THE INVENTION

While known connectors may provide for isolation between adjacent conductors, the continued trend toward higher signal speeds and miniaturization of electronic components and connectors increase parasitic crosstalk between the conductors. This makes the effectiveness of known connectors problematic in such environments

High speed data applications require reduced loss and adjacent signal line crosstalk in order to maintain signal integrity. Miniaturization of electronic components and closer signal lines can exacerbate losses, and therefore present new challenges in the design and manufacture of interconnects for present and high speed interconnects. To maintain signal integrity in advanced high speed components and interconnects, low dielectric constant and low loss materials are desired that are moldable and amenable to high volume manufacturing.

For the reasons stated above, and for other reasons stated below which will become apparent to those skilled in the art upon reading and understanding the present specification, there is a need in the art for alternative insulating materials and methods of their use in an integrated circuit and other substrates and connectors.

### SUMMARY OF THE INVENTION

An embodiment is directed to connectors and/or substrates, such as, but not limited to, printed circuit boards, which are made utilizing low dielectric constant (Dκ) injection moldable polymers, such as, but not limited to, thermoplastic materials, thermoplastic composite materials, thermoset materials, thermoset composite materials or a combination thereof and which support high speed conductive paths or signal lines. The low dielectric constant composite provides structural integrity to the connector and/or substrate and provides dielectric shielding between adjacent high speed signal lines. The reduced dielectric constant and reduced loss-tangent injection molded polymer is created by forming voids or pores within the bulk plastic material, thus increasing the air or void content, and thus decreasing the density and overall dielectric constant of the composite. This porosity introduced into the shielding between adjacent transmission lines reduces crosstalk and other losses, while maintaining signal integrity in ever-shrinking connector/substrate designs.

An embodiment is directed to an injection molded connector for use with high speed signal lines. The connector includes a housing with voids therein. The housing is molded or otherwise manufactured from thermoplastic materials, thermoplastic composite materials, thermoset materials, thermoset composite materials or a combination thereof. The housing provides dielectric shielding between adjacent high speed signal lines. The housing also provides structural integrity to the connector. The voids are formed in the housing to increase the porosity thereof. The voids are at least partially filled with air, thereby reducing the effective dielectric constant of the housing below the dielectric constant of the unfilled or nonporous materials, such as thermoplastic materials, thermoplastic composite materials, thermoset materials, thermoset composite materials or a combination thereof. The porosity of the housing reduces crosstalk between the signal lines, allowing for high signal propagation speed and decreased power consumption.

An embodiment is directed to a composite used to form housings for a connector or substrate which supports conductive paths of improved signal integrity. The composite includes voids formed in or added to the material to reduce the density of the material and decrease the effective dielectric constant of the composite. The voids are at least partially filled with air or other gas having a dielectric constant of less than 2. The porosity of the composite reduces the effective dielectric constant, which as a result reduces crosstalk between the lines supported by the housings, as the housings provide shielding between adjacent conductive paths.

In one embodiment the size of the voids in the composite is between 0.1 microns and 5000 microns.

In one embodiment the void volume of the composite is between greater than 0% and 90%.

In one embodiment the effective dielectric constant of the porous material or composite is between 2 and 5.

In one embodiment hollow glass spheres (HGS) containing air are integrated into the material.

In one embodiment the voids comprise gas-containing or otherwise expandable particles integrated into the material; the gas containing particles expand when exposed to heat, whereby the effective dielectric constant of the material can be changed by the expansion of the gas containing particles.

In one embodiment the voids are formed by injecting a supercritical fluid, such as, but not limited to, CO₂ or N₂, wherein the supercritical fluid acts like a foaming additive, creating porosity throughout the composite.

An embodiment is directed to a method of making a composite used to form a housing for a connector or substrate which supports conductive paths of improved signal integrity at high signal speeds. The method includes forming voids in the material to decrease the density of the material thus decreasing the effective dielectric constant of the composite, the voids containing air or other gas having a dielectric constant of less than 2.

An embodiment is directed to a composite used to form a housing for a connector or substrate which supports high speed lines or conductors. The composite includes a material comprising two or more of the above referenced methods, such as, but not limited to, HGS and supercritical fluid or HGS and expandable particles.

Other features and advantages of the present invention will be apparent from the following more detailed description of the preferred embodiment, taken in conjunction with the accompanying drawings which illustrate, by way of example, the principles of the invention.

### BRIEF DESCRIPTION OF THE DRAWINGS

FIG. 1 is a schematic representation a low dielectric composite having voids according to the present invention.

FIG. 2 is a diagrammatic view of an injection molding process in which supercritical fluid is introduced into a low dielectric constant material to form a composite of the present invention.

FIG. 3 is an image of an illustrative material of the present invention showing hollow glass spheres (HGS) integrated therein.

FIG. 4 is a schematic representation of particles within the composite, the particles shown expanding with exposure to heat.

FIG. 5 is a graph of the predicted dielectric constant of porous/foamed polymers based in porosity or void volume.

FIG. 6 is a perspective view of a representative connector which may use the low dielectric material of the present invention.

### DETAILED DESCRIPTION OF THE INVENTION

The description of illustrative embodiments according to principles of the present invention is intended to be read in connection with the accompanying drawings, which are to be considered part of the entire written description. In the description of embodiments of the invention disclosed herein, any reference to direction or orientation is merely intended for convenience of description and is not intended in any way to limit the scope of the present invention. Relative terms such as “lower,” “upper,” “horizontal,” “vertical,” “above,” “below,” “up,” “down,” “top” and “bottom” as well as derivatives thereof (e.g., “horizontally,” “downwardly,” “upwardly,” etc.) should be construed to refer to the orientation as then described or as shown in the drawing under discussion. These relative terms are for convenience of description only and do not require that the apparatus be constructed or operated in a particular orientation unless explicitly indicated as such. Terms such as “attached,” “affixed,” “connected,” “coupled,” “interconnected,” and similar refer to a relationship wherein structures are secured or attached to one another either directly or indirectly through intervening structures, as well as both movable or rigid attachments or relationships, unless expressly described otherwise. Moreover, the features and benefits of the invention are illustrated by reference to the preferred embodiments. These embodiments are described in sufficient detail to enable those skilled in the art to practice the invention, and it is to be understood that other embodiments may be utilized and that process, electrical or mechanical changes may be made without departing from the scope of the present invention. Accordingly, the invention expressly should not be limited to such preferred embodiments illustrating some possible non-limiting combination of features that may exist alone or in other combinations of features; the scope of the invention being defined only by the appended claims and equivalents thereof.

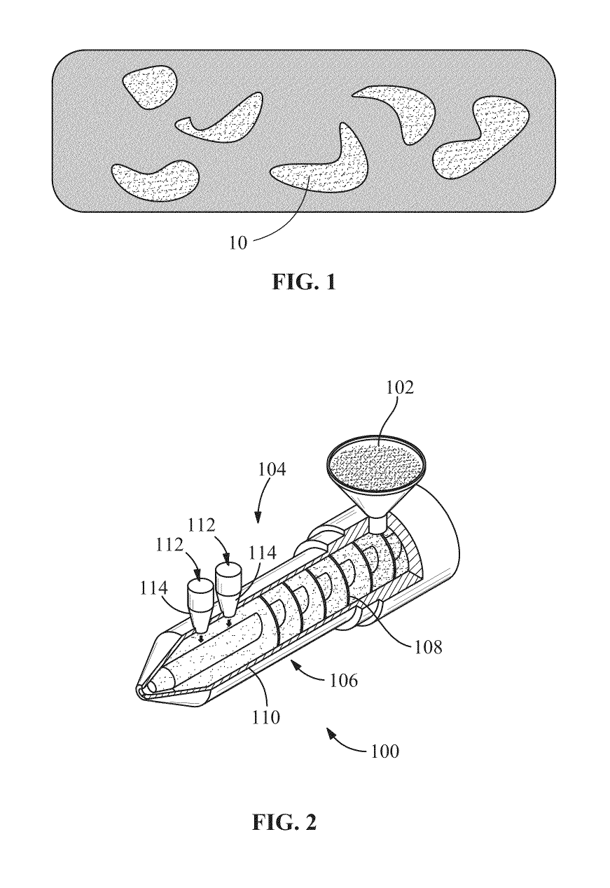

The embodiments described herein are connectors and/or substrates, such as, but not limited to, interconnects, which are made utilizing polymer composites having a low dielectric constant (Dκ) injection moldable or other melt processable material, such as, but not limited to, thermoplastic materials, thermoplastic composite materials, thermoset materials, thermoset composite materials or a combination thereof, and which support noise and/or crosstalk reductions for high speed signal transmission. The low dielectric constant composite provides structural integrity to the connector and/or substrate and provides dielectric shielding between adjacent high speed signal lines. The reduced dielectric constant and reduced loss-tangent are created by the addition of voids, void spaces or pores 10 (FIG. 1) within the bulk plastic material, thus increasing the existing air or void content and decreasing the effective dielectric constant of the material. The porosity introduced into the shielding between adjacent transmission lines reduces crosstalk and other losses and maintains signal integrity in ever-shrinking connector/substrate designs. In various embodiments, enhanced results in the composite may be obtained when the polymer materials are injection moldable and when the polymer materials have other desired characteristics, such as, but not limited to low heat deflection and high modulus. Representative materials include, but are not limited to, liquid crystal polymer (LCP), poly(p-phenylene sulfide) (PPS), polybutylene terephthalate (PBT), polyamide (nylon), fluorinated polymers, other high performance polymer materials, and other materials suitable for connector and shielding applications or combinations thereof.

Low-dielectric constant composite implementation allows continued scaling of connectors and substrates. The insulating material houses signal lines or conductors and separates the conducting paths (terminals, conductive paths and the like) from one another. As the connectors and substrates are scaled down and the signal lines are positioned closer together, the insulating dielectrics have thinned to the point where crosstalk degrades signal propagation speed and increases power consumption, thereby adversely affecting the performance of the interconnect. Replacing traditional insulating material with a low-dielectric constant composite of the same thickness reduces such obstacles.

As shown and described herein, polymer materials are modified to include pores or voids which are at least partially filled with air or other gases with low dielectric constant to form composites. Such dielectric constants are less than 2, less than 1.5, between 1 and 2, or any combination or subcombination thereof. As an example, as the dielectric constant (Dk) of air is slightly above 1, the dielectric constants of the unfilled or nonporous polymer materials (which generally have a dielectric constant above 4) can be lowered by the integration of voids, which are at least partially filled with air, in the polymer material. Consequently, the polymer composite (also termed polymer matrix), comprising the polymer material and the voids, has a lower effective Dk than the polymer material without the voids. This allows the connector and/or substrate made with the polymer composite to have a low Dk. The dielectric constant of such materials is greater than 1, less than 6, between 1 and 6, or any combination or subcombination thereof.

One method of obtaining moldable polymer composites with a low dielectric constant is by integrating pores into the polymer material, by injection of a foaming agent such as a supercritical fluid.

In accordance with some embodiments of the invention, foamed polymer composites are utilized as an insulating material within a connector or a substrate. Polymer materials are meant to include materials having properties which provide strength and structural integrity, such as not limited to, materials characterized by having at least one of high ductility, low elastic modulus, and low compressive yield strength. However, any polymer materials capable of being foamed are suitable for use in accordance with the present invention.

The use of foamed polymer materials advantageously provides a lower dielectric constant insulating composite within the connector or substrate than the same polymer materials which have not been foamed. The lower dielectric constant of such foamed polymeric composite allows its advantageous use in connector and/or substrates where crosstalk/noise has typically been problematic.

Foamed polymer composites have many advantages. For example, unlike conventional thermoplastic materials or thermoplastic composite materials used in connectors or substrates, which have a dielectric constant greater than 3.0, the polymer composite utilized in the porous insulating material of the present invention can have lower dielectric constants of less than 3.0.

Voids or cells are formed in the polymer composite by foaming the polymer materials. The foamed polymer composites composite material is readily characterized by the number and size of the cells distributed therein. Cell, as used herein, refers to an enclosed region of air or other gaseous or fluidic component, such as but not limited to nitrogen or carbon dioxide. The size of a cell is determined by the nominal diameter of the enclosed region of gas. Preferably, the size of cells according to the present invention is no greater than 100 microns, no smaller than 0.1 micron, between 0.1 micron and 100 microns or any combination or subcombination thereof. In illustrative embodiments it is desirable to have small cell sizes so that the polymer composites can be utilized in dielectric or shield housings, such as, but not limited to, thin walls or small trenches, between the signal lines of the connector and/or substrate.

In one embodiment, a supercritical fluid is utilized to convert the polymer materials into foamed polymer composite. Such use of supercritical fluids facilitates formation of sub-micron and micron scale cells in the foamed polymer composite. A gas is determined to be in a supercritical state (and is referred to as a supercritical fluid) when it is subjected to a combination of pressure and temperature above its critical point, such that its density approaches that of a liquid (i.e., the liquid and gas state coexist). A wide variety of compounds and elements can be converted to the supercritical state in order to be used to form the foamed polymer composite.

Preferably, the supercritical fluid is selected from the group including, but not limited to, N₂, CO₂ and/or combinations thereof. Although these and other fluids may be used, it is preferable to have a fluid with a low critical pressure, preferably below 100 atmospheres, and a low critical temperature of at or near room temperature. Further, it is preferred that the fluids be nontoxic and nonflammable. Likewise, the fluids should not degrade the properties of the polymer materials used or the surrounding conductive pathways. For one embodiment, supercritical fluid CO₂ is utilized, due to the relatively inert nature of CO₂ with respect to most polymer materials as well as other materials utilized in the fabrication of the connectors or substrates. Furthermore, the critical temperature is 31° Celsius (C) and critical pressure is 7.38 megapascal (MPa)(72.8 atmosphere (atm)) of CO₂. Thus, when CO₂ is subjected to a combination of pressure and temperature above 7.38 MPa (72.8 atm) and 31° C., respectively, it is in the supercritical state.

Referring now to FIG. 2, an illustrative process for producing the foamed composite of the present invention is shown. In a first step of the process, polymer materials, as described above are loaded into a hopper 102 of an extruder 104 and transported through a conveying section 106 using a plasticizing screw 108 located in a barrel 110. The material is transported along the conveying section 106 of the injection molding machine 100 and is heated as it is moved through the conveying section 106 using the friction from shearing pellets of the material between the screw and the walls of the extruder barrel and/or any suitable heating means (e.g., heat from shear or heat from an electrical source) The supercritical fluid 112 is introduced into the material in the conveying section 106 through an appropriately dimensioned nozzle or nozzles 114. The supercritical fluid is introduced at the appropriate temperature and pressure as described above. The nozzle directly controls the amount of the supercritical fluid 112 which enters the conveying section 106 by controlling the gas flow rate or pressure. Controlling the rate of flow or the pressure of the supercritical fluid 112 can be achieved using a pump (not shown) together with the backpressure regulator or any other suitable control unit (not shown). In one embodiment, the pump has two operating modes, namely, constant pressure and constant flow rate. Use of the appropriate sized pump in the constant pressure mode allows for the control of the formation of cells of the supercritical fluid 112.

The resulting melted composite (material laden with the supercritical fluid) is directed into one or more molds of the injection molding machine 100 via a suitable system of runners and gates. A rapid pressure drop as the supercritical fluid-laden melt leaves the conveying section 106 and enters into the mold(s) leads to the foaming of the material (i.e. nucleation of the cells of supercritical fluid), thereby forming microcellular injection molded parts having a porosity or void volume, which is the volume of the voids as a percentage of the total volume of the polymer materials, of between greater than 0% to 90%, greater than 0%, less than 90%, between 10% and 70%, between 20% and 50%, 30% or any combination or subcombination thereof.

The supercritical foaming process is used for weight and material reduction of components, reducing warpage, and reducing the viscosity of a polymer melt in manufacturing. The process has not been used to produce foamed composite for use in a low dielectric constant connector or substrate to provide dielectric shielding between adjacent high speed signal lines.

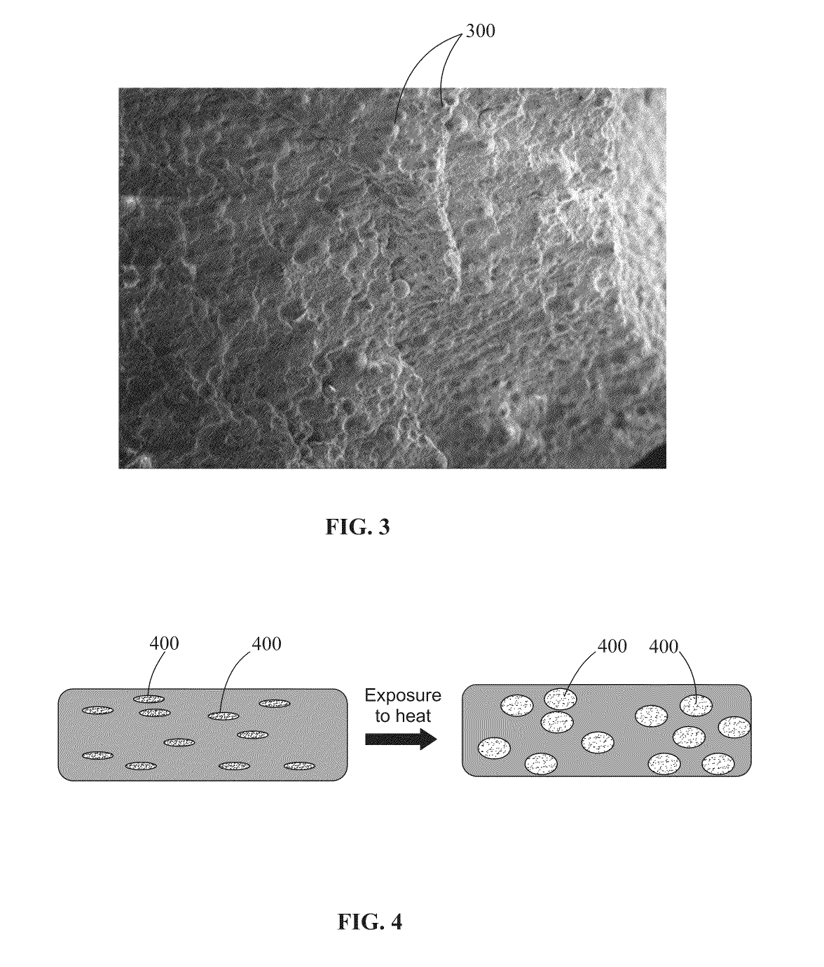

Another method of obtaining a moldable polymer composite with a low-dielectric constant is by integrating spheres containing air or other gases or combinations of gases, such as, but not limited to, air, oxygen, carbon dioxide, nitrogen, argon and helium and which are encapsulated in a shell made of materials such as, but not limited to glass or ceramic, as shown in FIG. 3.

Hollow glass spheres (HGS) are low density additives which are added to the polymer composite to provide a lower dielectric constant insulating material within the connector or substrate than the same polymer materials which do not include the spheres. They are also used to provide mechanical reinforcement in the same way glass fibers are used in conventionally molded plastics. Polymer materials with integrated spheres combine the dielectric constant of air (slightly above 1.0) and reinforcing properties of the glass shell with the mechanical strength of the polymeric composite. The polymeric composite behaves as a matrix for porous structures formed from polymeric materials containing air. The lower dielectric constant of such polymeric composite with integral HGS allows for use in connectors or substrates where noise and/or crosstalk have typically been problematic, as it provides relief for noise/crosstalk problems.

HGS impregnated polymer materials have many advantages. For example, unlike conventional thermoplastic material or thermoplastic composite material used in connectors or substrates, the HGS impregnated polymer materials utilized in the porous insulating composite of the present invention can produce lower dielectric constants.

HGS is added by compounding or mixing the polymer materials with the spheres. The polymer composite, is readily characterized by the number and size of the spheres distributed therein. The size of a sphere is determined by the nominal diameter of the enclosed region of gas. Preferably, the size of spheres according to the present invention is no greater than 5000 microns, no smaller than 1 micron, between 1 micron and 5000 microns, between 10 microns and 2000 microns or any combination or subcombination thereof. In illustrative embodiments, it is desirable to have small sphere sizes so that the polymer composite can be utilized in thin walls or small trenches. As long as the maximum sphere size is very small (for example 1/10 or less) compared to the width of the walls or trenches, adequate electrical insulation can be provided without a potentially detrimental reduction in mechanical integrity of the walls or trenches.

The use of air or other gas filled spheres is beneficial as it allows for the ability to form highly-filled connectors and or substrates with more complex geometries. The integration of glass spheres into the polymer material to form a polymer composite yields overall structural integrity capable of supporting a connector and/or substrate.

Referring to FIG. 4, another method of obtaining a moldable polymer composite with a low-dielectric constant is by integrating expandable particles 400 into the polymer materials, the particles containing, but not limited to, nitrogen, air, carbon dioxide, oxygen, argon, or helium.

The particles or microspheres, such as but not limited to those sold by Akzo Nobel under the name of Expancel Microspheres, are additives which are added to the polymer materials to provide a lower dielectric constant composite within the connector or substrate than the unfilled or nonporous materials. The lower dielectric constant of such polymeric material with integrated particles allows for use in connectors or substrates where noise/crosstalk may be problematic.

Polymers impregnated with low Dk particles to form polymer composites have many advantages. For example, unlike conventional thermoplastic material or thermoplastic composite material used in connectors or substrates, the particle impregnated polymer composites utilized in the porous insulating material of the present invention can have lower dielectric constants.

Preferably, the size of voids according to this embodiment is no greater than 100 microns, no smaller than 0.1 micron, between 0.1 micron and 100 microns or any combination or subcombination thereof. In illustrative embodiments, it is desirable to have small void sizes so that the polymer composite can be utilized in thin walls or small trenches. As long as the maximum void size of the polymer composite is very small compared to the width of the walls or trenches, adequate electrical insulation can be provided.

During manufacture, the moldable polymer materials with the expandable particles are exposed to heat, causing the expandable particle to expand to create regions of low density in the composite.

The integration of expandable particles offers a method to tune the dielectric constant by modifying heat exposure and/or other processing parameters, which in turn controllably expands the particles and the resulting regions of low density, resulting in lowered effective Dk of the composite.

The resulting melted material laden with the expandable particles is directed into one or more molds of the injection molding machine 100 via a suitable system of runners and gates. This results in injection molded parts having a porosity or void volume of between greater than 0% to 90%, greater than 0%, less than 90%, between 10% and 70%, between 20% and 50%, 30% or any combination or subcombination thereof.

Regardless of the method of manufacture of the porous polymer composites, the effective Dk, or Dk_{eff}, for the air-filled composites may be predicted using the following formula:

$$v ( \frac{{Dk}_{eff} - {Dk}_{1}}{2 {Dk}_{eff} + {Dk}_{1}} ) + ( 1 - v ) ( \frac{{Dk}_{eff} - {Dk}_{2}}{2 {Dk}_{eff} + {Dk}_{2}} ) = 0$$

where:
v=void volume content
Dk₁=dielectric constant of air
Dk₂=dielectric constant of polymer medium
Dk_{eff}=effective dielectric constant

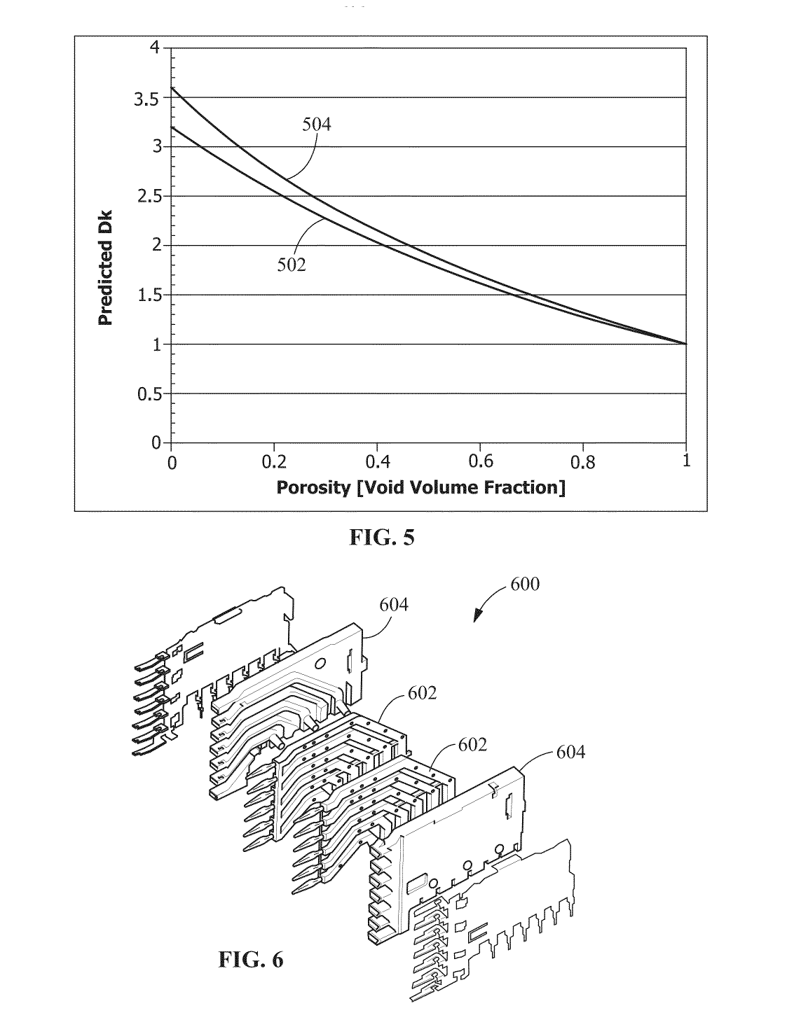

FIG. 5 shows the Dk_{eff} of the composite may be tailored by modifying the void volume fraction which is influenced by the content of the foaming agent, supercritical fluid, spheres or particles which are used. The Dk_{eff} for an LCP material is represented by 502. The Dk_{eff} for a PPS material is represented by 504.

An example of a connector benefiting from a low-dielectric constant composite of the present invention is shown in FIG. 6. This connector 600 is a modular system comprising high speed signal lines 602 and an overmolded housing 604. When using polymer materials which have no induced voids or cells, the connector is subject to crosstalk which degrades signal integrity and increases power consumption, thereby adversely affecting the performance of the connector.

The use of the polymer composites, including, but not limited to, polymer materials, which have been foamed, impregnated with spheres, or impregnated with other low Dk particles to lower the dielectric constant of the composite can be molded, extruded, or otherwise assembled using traditional tooling and manufacturing methods.

While the invention has been described with reference to one or more embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims. In addition, all numerical values identified in the detailed description shall be interpreted as though the precise and approximate values are both expressly identified.

1. An injection molded connector for use with high speed signal lines, the connector comprising:
a housing injection molded from thermoplastic materials, thermoplastic composite materials, thermoset materials, thermoset composite materials or a combination thereof, the housing providing dielectric shielding between adjacent high speed signal lines, the housing providing structural integrity to the connector;
voids formed in the housing to increase the porosity of the housing, the voids being at least partially filled with air, thereby reducing an effective dielectric constant of the housing below the dielectric constant of the unfilled thermoplastic materials, thermoplastic composite materials, thermoset materials, thermoset composite materials or a combination thereof;
wherein the porosity of the housing reduces crosstalk between the signal lines, allowing for high signal propagation speed.

2. The injection molded connector as recited in claim 1, wherein the size of the voids is between 0.1 microns and 5000 microns.

3. The injection molded connector as recited in claim 1, wherein a volume of the voids as a percentage of a total volume of the thermoplastic materials, thermoplastic composite materials, thermoset materials, thermoset composite materials or a combination thereof is between greater than 0% and 90%.

4. The injection molded connector as recited in claim 1, wherein the effective dielectric constant of the housing is less than 6.

5. The injection molded connector as recited in claim 1, wherein the housing comprises liquid crystal polymer, poly(p-phenylene sulfide), polybutylene terephthalate, nylon, other thermoplastic or moldable polymer, thermoset polymer, or combinations thereof.

6. The injection molded connector as recited in claim 1, wherein the voids are formed by foaming.

7. The injection molded connector as recited in claim 1, wherein the voids are formed by injecting a supercritical fluid as a foaming agent.

8. The injection molded connector as recited in claim 7, wherein the voids are formed by CO₂.

9. The injection molded connector as recited in claim 7, wherein the voids are formed by N₂.

10. The injection molded connector as recited in claim 1, wherein the voids are gas-filled spheres integrated into the housing.

11. The injection molded connector as recited in claim 10, wherein the voids are gas-filled spheres encased in glass and integrated into the housing during molding.

12. The injection molded connector as recited in claim 1, wherein the voids are expandable particles integrated into a partition of the housing.

13. The injection molded connector as recited in claim 12, wherein the expandable particles expand when exposed to heat, whereby the effective dielectric constant of the housing can be changed by the expansion of the particles.

14. A composite used to form housings for a connector or substrate which supports conductive paths of improved signal integrity, the composite comprising:
thermoplastic materials, thermoplastic composite materials, thermoset materials, thermoset composite materials or a combination thereof;
voids formed in the composite to reduce the density of the material thus decreasing an effective dielectric constant of the composite, the voids being at least partially filled with air or other gas having a dielectric constant less than 2;
wherein the porosity of the composite reduces crosstalk between the conductive paths supported by the housings which provide shielding between adjacent conductive paths.

15. The composite as recited in claim 14, wherein the size of the voids is between 0.1 microns and 5000 microns.

16. The composite as recited in claim 14, wherein a volume of the voids as a percentage of a total volume of the thermoplastic materials, thermoplastic composite materials, thermoset materials, thermoset composite materials or a combination thereof is between greater than 0% and 90%.

17. The composite as recited in claim 14, wherein the effective dielectric constant of the composite is between less than 6.

18. The composite as recited in claim 14, wherein the voids integrated into the composite are gas-filled glass spheres.

19. The composite as recited in claim 14, wherein the voids are formed by the addition of expandable particles which contain gas in their expanded form when integrated into the composite, the particles expanding when exposed to heat, whereby the effective dielectric constant of the composite can be changed by the controlled expansion of the gas-containing particles.

20. A method of making a composite used to form a housing for a connector or substrate which supports conductive paths of improved signal integrity at high signal speeds, the method comprising:
forming voids in a material to decrease the density of the material thus decreasing the effective dielectric constant of the material, the void being filled with air or other gas having a dielectric constant of less than 2.
